(19) United States
(12) Patent Application Publication
(10) Pub. No.: US 2020/0372874 A1
(43) Pub. Date: Nov. 26, 2020

(54) LCD DEVICE AND DRIVING METHOD THEREOF

(71) Applicants: HKC Corporation Limited, Shenzhen, Guangdong (CN); Chongqing HKC Optoelectronics Technology Co., Ltd., Chongqing (CN)

(72) Inventor: SHUI-XIU HU, Chongqing (CN)

(21) Appl. No.: 16/959,823

(22) PCT Filed: Dec. 29, 2018
(86) PCT No.: PCT/CN2018/125455

§ 371 Date: Jul. 2, 2020

(30) Foreign Application Priority Data
Jan. 3, 2018 (CN) 201810003518.9

(51) Int. Cl. G09G 3/36

(52) U.S. Cl. CPC G09G 3/3688; G09G 3/3677; G09G 2330/026; G09G 2320/0209; G09G 2300/0809; G09G 2320/0247; G09G 2300/0426

(57) ABSTRACT

An LCD device and driving method thereof are disclosed. The display panel of the LCD device comprises plural pixels. Each pixel has plural first switch elements, plural pixel electrodes and a common electrode. A drive circuit is electrically connected to the pixel electrodes through the first switch elements, respectively. The method comprises: when the LCD device is at a booting-up moment and a trigger signal turns on the first switch elements at a first time point, the drive circuit enables a common electrode voltage to be transmitted to the pixel electrodes at the first time point, and then when a rising edge of a start signal of a first frame image is received at a second time point after the first time point, the drive circuit enables plural data voltages to be transmitted to the pixel electrodes through the first switch elements, so the pixels display an image.

### BACKGROUND OF THE INVENTION

### Technical Field

This disclosure relates to a liquid crystal display device and a driving method thereof, and more particularly to a liquid crystal display device and a driving method thereof capable of eliminating a white flickering phenomenon from a frame at a booting-up moment.

### Related Art

With the advancement of technology, flat panel displays (more particularly liquid crystal display devices) have been widely used in various fields, and thus have the superior features including the thin body, the low power consumption and the radiationless property, gradually replaced the conventional Cathode Radial Tube display devices, and applied to various electronic products, such as mobile phones, portable multimedia devices, notebook computers, liquid crystal televisions, liquid crystal screens and the like.

In the well-known art, in order to make the liquid crystal display device display an image, a voltage difference between a pixel electrode and a common electrode of each pixel needs to be applied to change the rotating angles of the liquid crystal molecules, to thereby change the light transmittance and display different frames. A data voltage is inputted to the pixel electrode, while a common electrode voltage (Vcom) is inputted to the common electrode.

However, at the booting-up moment of the liquid crystal display device, the data voltage cannot be immediately applied to the pixel electrode. At this time, however, the common electrode voltage has been applied to the common electrode, so that the voltage difference between the pixel electrode and the common electrode is equal to the common electrode voltage, and the panel frame appears the white flickering phenomenon at the booting-up moment.

### SUMMARY

In view of the deficiencies of the prior art, the inventor has obtained this disclosure after the research and development have been made. An objective of this disclosure is to provide a display device capable of improving a vertical crosstalk problem.

To achieve the above objective, the present disclosure discloses a method of driving a liquid crystal display device. The liquid crystal display device has a display panel and a drive circuit electrically connected to the display panel. The display panel comprises a plurality of pixels. Each of the plurality of pixels has a plurality of first switch elements, a plurality of pixel electrodes and a common electrode. The drive circuit is electrically connected to the plurality of pixel electrodes through the plurality of first switch elements, respectively. The method comprises: when the liquid crystal display device is at a booting-up moment and a trigger signal turns on the plurality of first switch elements at a first time point, the drive circuit enables a common electrode voltage to be transmitted to the plurality of pixel electrodes at the first time point, and then when a rising edge of a start signal of a first frame image is received at a second time point after the first time point, the drive circuit enables a plurality of data voltages to be transmitted to the plurality of pixel electrodes through the plurality of first switch elements, so that the plurality of pixels display an image.

To achieve the above objective, the present disclosure also discloses a liquid crystal display device. The liquid crystal display device comprises a display panel and a drive circuit. The display panel comprises a plurality of pixels, wherein each of the plurality of pixels has a plurality of first switch elements, a plurality of pixel electrodes and a common electrode. The drive circuit is electrically connected to the display panel and electrically connected to the plurality of pixel electrodes through the plurality of first switch elements, respectively. When the liquid crystal display device is at a booting-up moment and a trigger signal turns on the plurality of first switch elements at a first time point, the drive circuit enables a common electrode voltage to be transmitted to the plurality of pixel electrodes at the first time point. When a rising edge of a start signal of a first frame image is received at a second time point after the first time point, the drive circuit enables a plurality of data voltages to be transmitted to the plurality of pixel electrodes through the plurality of first switch elements, so that the plurality of pixels display an image.

In one embodiment, the drive circuit comprises a source driver and a common-electrode voltage drive circuit; the common-electrode voltage drive circuit comprises a plurality of second switch elements, a third switch element and a logic control circuit; the plurality of second switch elements are correspondingly disposed on a plurality of data lines; and the source driver is electrically connected to the plurality of pixel electrodes through the plurality of data lines, the plurality of second switch elements and the plurality of first switch elements, respectively.

In one embodiment, when the trigger signal is a first trigger level at the first time point, the third switch element turns on, the logic control circuit controls the plurality of second switch elements to turn off, and the source driver enables the common electrode voltage to be transmitted to the plurality of pixel electrodes through the plurality of data lines, the third switch element and the plurality of first switch elements, respectively.

In one embodiment, when the trigger signal is a second trigger level to turn on the plurality of second switch elements, the third switch element turns off, and the source driver transmits the plurality of data voltages to the plurality of pixel electrodes through the plurality of data lines, the plurality of second switch elements and the plurality of first switch elements.

In one embodiment, the logic control circuit is a NOT gate.

In one embodiment, the drive circuit has a gate driver and a source driver, the gate driver is electrically connected to the plurality of first switch elements of the plurality of pixels, and the source driver is electrically connected to the plurality of first switch elements through a plurality of data lines.

In one embodiment, when the trigger signal is a first trigger level at the first time point, the gate driver controls the plurality of first switch elements to turn on, and an enable signal controls the source driver to enable the common electrode voltage to be transmitted to the plurality of pixel electrodes through the plurality of data lines at the first time point.

In one embodiment, at the second time point, the enable signal controls the source driver to enable the plurality of data voltages to be transmitted to the plurality of pixel electrodes through the plurality of data lines.

In one embodiment, the drive circuit comprises a gate driver, and the trigger signal further enables the gate driver to control the plurality of first switch elements to turn on through a plurality of gate lines at the first time point.

To achieve the above objective, the present disclosure further discloses a liquid crystal display device. The liquid crystal display device comprises a display panel and a drive circuit. The display panel comprises a plurality of pixels, wherein each of the plurality of pixels has a plurality of first switch elements, a plurality of pixel electrodes and a common electrode. The drive circuit is electrically connected to the display panel and electrically connected to the plurality of pixel electrodes through the plurality of first switch elements, respectively. When the liquid crystal display device is at a booting-up moment and a trigger signal turns on the plurality of first switch elements at a first time point, the drive circuit enables a common electrode voltage to be transmitted to the plurality of pixel electrodes at the first time point. When a rising edge of a start signal of a first frame image is received at a second time point after the first time point, the drive circuit enables a plurality of data voltages to be transmitted to the plurality of pixel electrodes through the plurality of first switch elements, so that the plurality of pixels display an image. The drive circuit comprises a source driver and a common-electrode voltage drive circuit. The common-electrode voltage drive circuit comprises a plurality of second switch elements, a third switch element and a logic control circuit. The plurality of second switch elements are correspondingly disposed on a plurality of data lines. The source driver is electrically connected to the plurality of pixel electrodes through the plurality of data lines, the plurality of second switch elements and the plurality of first switch elements, respectively. When the trigger signal is a first trigger level at the first time point, the third switch element turns on, the logic control circuit controls the plurality of second switch elements to turn off, and the source driver enables the common electrode voltage to be transmitted to the plurality of pixel electrodes through the plurality of data lines, the third switch element and the plurality of first switch elements, respectively. When the trigger signal is a second trigger level to turn on the plurality of second switch elements, the third switch element turns off, and the source driver transmits the plurality of data voltages to the plurality of pixel electrodes through the plurality of data lines, the plurality of second switch elements and the plurality of first switch elements.

As mentioned above, with the above-mentioned liquid crystal display device and the driving method thereof, this disclosure has the advantages of the simple control and low cost, and also completely eliminates the white flickering phenomenon of the liquid crystal display device at the booting-up moment and improves the frame quality of the liquid crystal display device.

### BRIEF DESCRIPTION OF THE DRAWINGS

The accompanying drawings are included to provide a further understanding of embodiments of the present application, which constitutes a part of the specification, illustrate embodiments of the present disclosure is used, together and explain the principles of the present disclosure with the description. Apparently, the drawings in the following description are only some embodiments of the present disclosure, those of ordinary skill in the art is concerned, without any creative effort, and may also obtain other drawings based on these drawings. In the following drawings:

FIG. 1A is a schematic functional block diagram showing a liquid crystal display device of an embodiment;

FIG. 1B is a schematic view showing a pixel in a liquid crystal display device of an embodiment;

FIG. 2 is a schematic view showing a step of a driving method of a liquid crystal display device of a first embodiment of this disclosure;

FIG. 3 is a schematic view showing a control circuit of an output control of a common electrode voltage of an embodiment;

FIG. 4 is a schematic view showing signal waveforms of FIG. 3;

FIG. 5 is a schematic circuit diagram showing that a source driver of a drive circuit of a liquid crystal display device is electrically connected to a plurality of pixels of a display panel through a plurality of switch elements in another embodiment;

FIG. 6 is a schematic view showing signal waveforms of FIG. 5;

FIG. 7 is a schematic view showing steps of a driving method of a liquid crystal display device of a second embodiment of this disclosure;

FIG. 8 is a schematic circuit connection diagram showing a source driver, a gate driver and a plurality of pixels of a liquid crystal display device of another embodiment; and

FIG. 9 is a schematic view showing signal waveforms of FIG. 8.

### DETAILED DESCRIPTION OF THE INVENTION

Specific structural and functional details disclosed herein are merely representative and are for purposes of describing example embodiments of the present disclosure. However, the present disclosure may be embodied in many alternate forms, and should not be interpreted as being limited to the embodiments set forth herein.

In the description of the present disclosure, it is to be understood that the term “center”, “lateral”, “upper”, “lower”, “left”, “right”, “vertical”, “horizontal”, “top”, “bottom”, “inner”, “outer” and other indicated orientation or positional relationships are based on the location or position relationship shown in the drawings, and are for convenience of description of the present disclosure only and to simplify the description, and not indicate or imply that refers to devices or elements must have a specific orientation, the orientation of a particular configuration and operation, therefore, cannot be construed as limiting the present disclosure. In addition, the terms “first”, “second” are used to indicate or imply relative importance or the number of technical features specified implicitly indicated the purpose of description and should not be understood. Thus, there is defined “first”, “second” features may be explicitly or implicitly include one or more of the features. In the description of the present disclosure, unless otherwise specified, the meaning of “more” is two or more. Further, the term “comprising” and any variations thereof are intended to cover non-exclusive inclusion.

In the description of the present disclosure, it is noted that, unless otherwise expressly specified or limited, the terms “mounted”, “connected to”, “connected” are to be broadly understood, for example, may be a fixed connection, may be a detachable connection, or integrally connected; may be a mechanical connector may be electrically connected; may be directly connected, can also be connected indirectly through intervening structures, it may be in communication the interior of the two elements. Those of ordinary skill in the art, be appreciated that the specific circumstances of the specific meanings in the present disclosure.

The terminology used herein is for describing particular embodiments only and is not intended to limit embodiments to an exemplary embodiment. Unless the context clearly indicates otherwise, singular forms as used herein, “a”, “an” are intended to include the plural. It should also be understood that, as used herein the term “comprising” and/or “comprising,” as used herein, specify the presence of stated features, integers, steps, operations, elements, and/or components, but do not preclude the presence or addition of one or more other features, integers, steps, operations, elements, components, and/or combinations thereof.

This disclosure will be further described in detail with reference to the accompanying drawings and specific embodiments below.

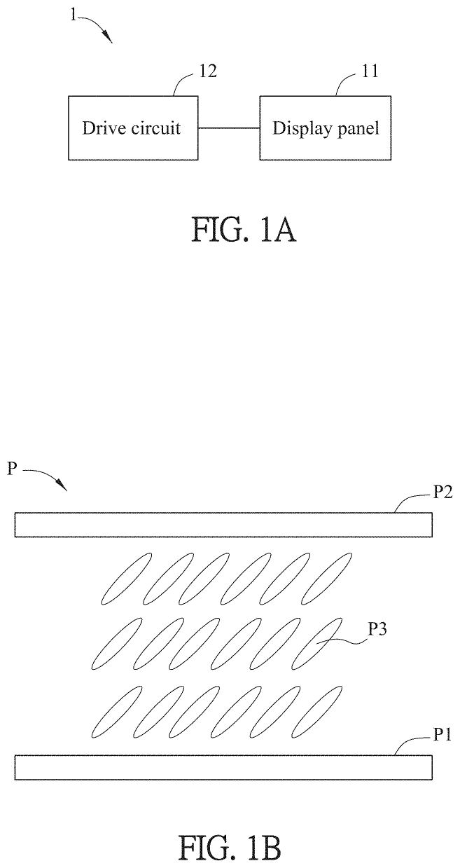

FIG. 1A is a schematic functional block diagram showing a liquid crystal display device of an embodiment, and FIG. 1B is a schematic view showing a pixel in a liquid crystal display device of an embodiment.

Referring to FIGS. 1A and 1B, a liquid crystal display device 1 has a display panel 11 and a drive circuit 12 electrically connected to the display panel 11. The display panel 11 may have a plurality of pixels P. Each of the pixels P may have a pixel electrode P1, a common electrode P2 and a plurality of liquid crystal molecules P3 interposed between the pixel electrode P1 and the common electrode P2. When the drive circuit 12 outputs a plurality of data voltages to the pixel electrodes P1 of the plurality of pixels P and outputs a common electrode voltage to be transmitted to the common electrodes P2 of the plurality of pixels P, a voltage difference is formed between the pixel electrode P1 and the common electrode P2, and the liquid crystal molecules P3 can be rotated to a certain angle to display the frame.

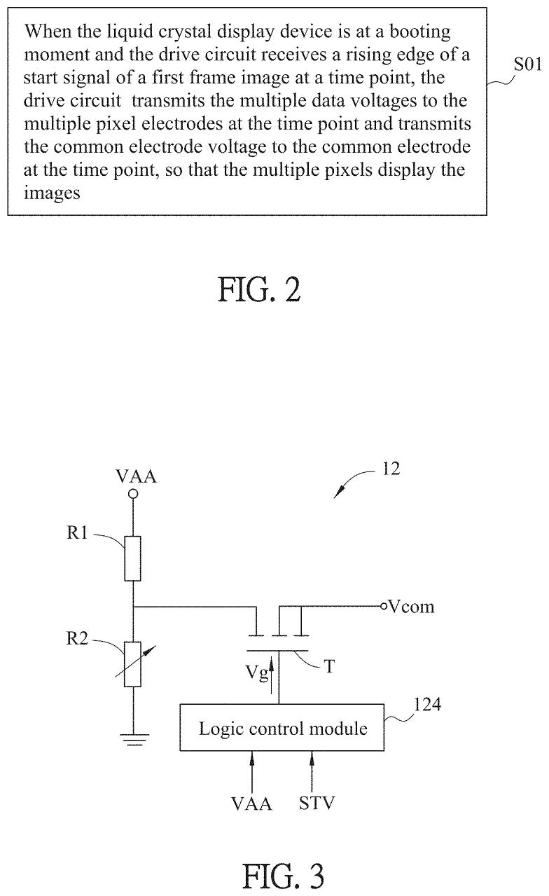

In some embodiments, the drive circuit 12 may include a gate driver, a source driver and a timing controller (not shown in FIGS. 1 and 2). The gate driver may be coupled to the display panel 11 through a plurality of gate lines, and the source driver may be coupled to the display panel 11 through a plurality of data lines. The timing controller may transmit a vertical synchronously start signal (STV) and a horizontal sync signal to the gate driver, convert the video signal received from the external port into the data voltage required by the source driver, and transmit the data signal and the horizontal sync signal to the source driver. The source driver may output a plurality of data voltages corresponding to the plurality of data lines to the pixel electrodes P1 of the plurality of pixels P, and output the common electrode voltage to the common electrode P2. In addition, the gate driver may sequentially turn on a plurality of gate lines at the beginning of a frame time according to the vertical synchronously start signal (STV). When the plurality of gate lines respectively and sequentially turn on, the source driver may correspondingly transmit the plurality of data voltages to the pixels P through the plurality of data lines, so that the display panel 11 can display images.

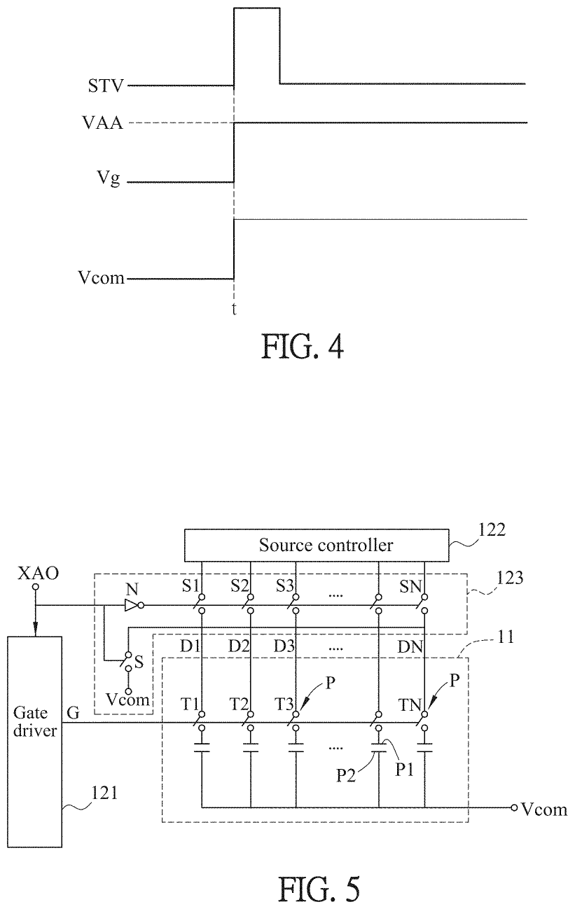

How to eliminate the white flickering phenomenon at the booting-up moment described in the background technology is described with reference to FIG. 2 in conjunction with FIGS. 3 and 4. Wherein, FIG. 2 is a schematic view showing a step of a driving method of a liquid crystal display device of a first embodiment of this disclosure, FIG. 3 is a schematic view showing a control circuit of an output control of a common electrode voltage of an embodiment, and FIG. 4 is a schematic view showing signal waveforms of FIG. 3.

Refer first to FIG. 3, the drive circuit 12 of this embodiment may also have a logic control module 124, the signal Vg outputted by the logic control module 124 may control a switch element T (e.g., a MOSFET) to turn on, so that the drive circuit 12 may output the common electrode voltage Vcom to the common electrode P2.

Referring to FIG. 2, the driving method of the liquid crystal display device of this embodiment includes a step S01. As shown in FIG. 2, when the liquid crystal display device is at a booting-up moment and the drive circuit 12 receives a rising edge of a start signal STV of a first frame image at a time point t, the drive circuit 12 transmits the plurality of data voltages to the plurality of pixel electrodes P1 at the time point t and transmits the common electrode voltage Vcom to the common electrode P2 at the time point t, so that the plurality of pixels P display the images.

In detail, in FIGS. 3 and 4, a control signal VAA always maintains a first trigger level (such as the high level). Also, when the system detects that the system is booted up and at the time point t and the rising edge of the start signal STV of the first frame image also comes (the high level), the signal Vg outputted by the logic control module 124 also becomes the high level, so that the switch element T is turned on. At this time, the drive circuit 12 enables the common electrode voltage Vcom to be outputted to the common electrode P2.

In other words, in this embodiment, when the control signal VAA and the start signal STV of the first frame image of the display panel 11 are the high levels, the logic control module 124 enables the common electrode voltage Vcom to be outputted and transmitted to the common electrode P2. Therefore, before the time point t (i.e., before the rising edge of the start signal STV), the common electrode voltage Vcom is not inputted to the common electrode P2. Meanwhile, the data voltage of the first frame image is not inputted to the pixel electrode P1, so the pixel voltage of each of the pixels P is 0 (the pixel voltage is the voltage difference between the pixel electrode P1 and the common electrode P2), thereby eliminating the white flickering phenomenon at the booting-up moment and thus improving the frame quality.

After the time point t, while the drive circuit 12 may transmit the plurality of data voltages of the first frame image to the plurality of pixel electrodes P1, the common electrode voltage Vcom is also transmitted to the common electrode P2, so that the pixel P may normally display the image frame. In this embodiment, the first trigger level may be the high level, and the logic control module 124 may include an AND gate. In other embodiments, the first trigger level may also be the low level, and the logic control module 124 may include a NOT AND gate.

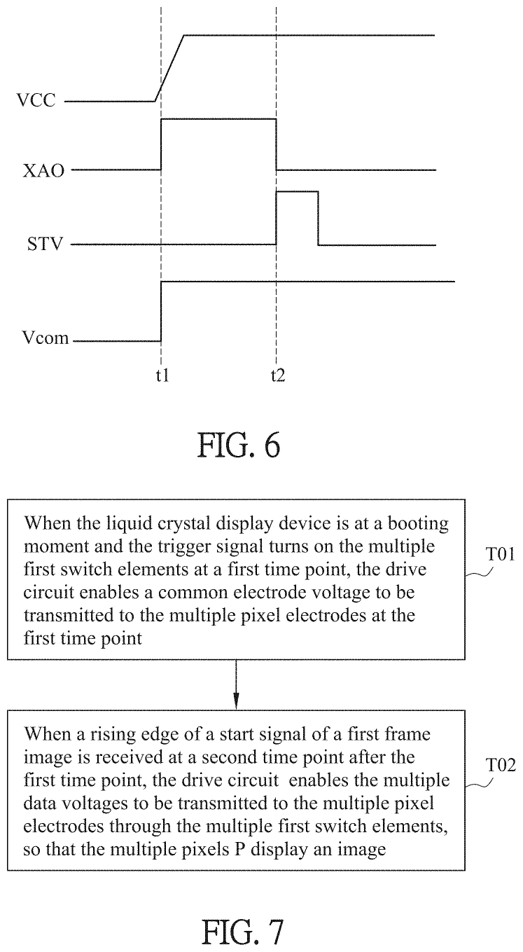

In addition, a liquid crystal display device of a second embodiment and a driving method thereof are described with reference to FIGS. 5 to 7. Wherein, FIG. 5 is a schematic circuit diagram showing that a source driver of a drive circuit of a liquid crystal display device is electrically connected to a plurality of pixels of a display panel through a plurality of switch elements in another embodiment, FIG. 6 is a schematic view showing signal waveforms of FIG. 5, and FIG. 7 is a schematic view showing steps of a driving method of a liquid crystal display device of a second embodiment of this disclosure.

In FIGS. 5 and 6, in addition to the pixel electrode P1 and the common electrode P2, the pixels P of the display panel 11 may further include a plurality of first switch elements T1 to TN (TFT), and a source driver 122 may be electrically connected to the plurality of pixel electrodes P1 through a plurality of data lines D1 to DN and a plurality of first switch elements T1 to TN. When a gate driver 121 controls the plurality of first switch elements T1 to TN of the plurality of pixels P to turn on through a gate line G, the source controller 122 may transmit the data voltages to the plurality of pixels P through the data lines D1 to DN, respectively.

In addition to the gate driver 121 and the source driver 122, the drive circuit 12 of this embodiment may further include a common-electrode voltage drive circuit 123. The common-electrode voltage drive circuit 123 may include a plurality of second switch elements S1 to SN, a third switch element S (e.g., MOSFET) and a logic control circuit. A plurality of second switch elements S1 to SN are correspondingly disposed on the plurality of data lines D1 to DN, and the source driver 122 may respectively electrically connected to the plurality of pixel electrodes P1 through the plurality of second switch elements S1 to SN, the plurality of data lines D1 to DN and the plurality of first switch elements T1 to TN. In addition, a trigger signal XAO may control the third switch element S and may control the plurality of second switch elements S1 to SN through the logic control circuit at the same time. When the logic control circuit enables the second switch elements S1 to SN to turn off (not turn on) and enables the third switch element S to turn on, the common electrode voltage Vcom may be transmitted to the plurality of pixel electrodes P1 through the third switch element S, the plurality of data lines D1 to DN and the plurality of first switch elements T1 to TN. In this embodiment, the logic control circuit is, for example but without limitation to, a NOT gate N.

As shown in FIG. 7, the driving method of the liquid crystal display device of this embodiment may include the steps. As shown in FIG. 7, in the step T01, when the liquid crystal display device is at a booting-up moment and the trigger signal XAO turns on the plurality of first switch elements T1 to TN at a first time point t1, the drive circuit 12 enables a common electrode voltage Vcom to be transmitted to the plurality of pixel electrodes P1 at the first time point t1. In the step T02, when a rising edge of a start signal STV of a first frame image is received at a second time point t2 after the first time point t1, the drive circuit 12 enables the plurality of data voltages to be transmitted to the plurality of pixel electrodes P1 through the plurality of first switch elements T1 to TN, so that the plurality of pixels P display an image.

In detail, when the system detects that the system is booted up (i.e., the VCC voltage rises), the trigger signal XAO is changed to the first trigger level at the first time point t1 (e.g., the high level), the third switch element S turns on, and the trigger signal XAO also enables the second switch elements S1 to SN to turn off (not turn on) through the NOT gate N. At the same time, the high level of the trigger signal XAO at the first time point t1 also enables the gate driver 121 to control the plurality of first switch elements T1 to TN to turn on through the gate line G. At this time, the common electrode voltage Vcom can be respectively transmitted to the plurality of pixel electrodes P1 through the third switch element S, the data lines D1 to DN, and the first switch elements T1 to TN at the first time point t1, so that all voltages of the pixel electrodes P1 of the pixels P are the common electrode voltages Vcom. Because the common electrode voltage Vcom is also transmitted to the common electrode P2, the pixel voltage of each of the pixels P is 0, so that the pixel voltage of the pixel P is zero in the period between the second time point t2 (before the rising edge of the start signal STV of the first frame image), thereby eliminating the white flickering phenomenon at the booting-up moment and thus improving the frame quality.

Thereafter, when the rising edge of the start signal STV of the first frame image comes at the second time point t2, the trigger signal XAO becomes the second trigger level (e.g., the low level), the third switch element S turns off, and the low level also causes the plurality of second switch elements S1 to SN to turn on. At this time, a gate controller 121 may sequentially transmit the gate signal through the gate line G to sequentially turn on the first switch elements T1 to TN, the drive circuit 12 may transmit the plurality of data voltages of the first frame image, and respectively transmit the plurality of data voltages of the first frame image to the plurality of pixel electrodes P1 through the plurality of second switch elements S1 to SN, the data lines D1 to DN and the first switch elements T1 to TN, so that the display panel 11 may normally display the image frame. The above-mentioned first trigger level is the high level, and the second trigger level is the low level for the illustrative purpose only. In different embodiments, the first and second trigger levels may be the low and high levels, respectively.

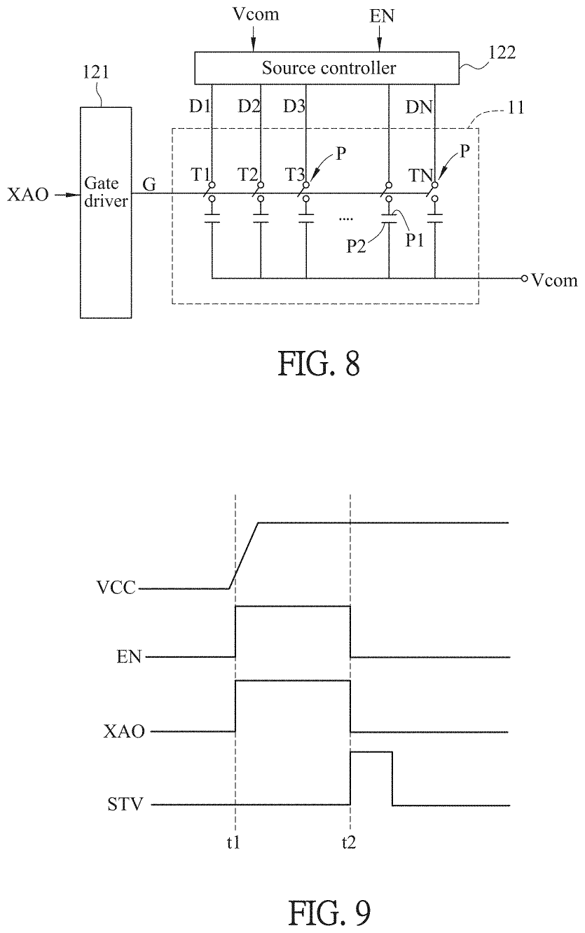

In addition, please refer to FIGS. 8 and 9 in conjunction with FIG. 7, wherein FIG. 8 is a schematic circuit connection diagram showing a source driver, a gate driver and a plurality of pixels of a liquid crystal display device of another embodiment, and FIG. 9 is a schematic view showing signal waveforms of FIG. 8.

In FIGS. 8 and 9, the source driver 122 may be electrically connected to the plurality of pixel electrodes P1 through the plurality of data lines D1 to DN and the plurality of first switch elements T1 to TN. In addition, the gate driver 121 is electrically connected to the plurality of first switch elements T1 to TN of the plurality of pixels P, and when the gate driver 121 respectively controls the plurality of first switch elements T1 to TN to turn on through the gate line G, a source controller 122 may transmit the voltage signals to the pixels P through the data lines D1 to DN.

In this embodiment, when the system detects that the system is booted up (i.e., the VCC voltage rises), the trigger signal XAO is changed to the first trigger level at the first time point t1 (e.g., the high level), so that the gate driver 121 controls the plurality of first switch elements T1 to TN to turn on through the gate line G. At this time, an enable signal EN also becomes the high level (the first trigger level), to control the source driver 122 to enable the common electrode voltage Vcom inputted to the high level of the source driver 122 to be transmitted to the plurality of pixel electrodes P1 at the first time point t1 through the data lines D1 to DN and the plurality of first switch elements T1 to TN, so that the pixel electrode P1 has the common electrode voltage Vcom, and the pixel voltage of each of the pixels P becomes zero, thereby eliminating the white flickering phenomenon at the booting-up moment and improving the frame quality.

After that, when the rising edge of the start signal STV of the first frame image comes at the second time point t2 after the first time point t1, all of the trigger signal XAO, the enable signal EN and the common electrode voltage Vcom inputted to the source driver 122 become the second trigger levels (for example, the low levels). At this time, the gate controller 121 may transmit the gate signal through the gate line G to sequentially turn on the first switch elements T1 to TN, and the enable signal EN controls the source driver 122 to enable the corresponding first frame image of the plurality of data voltages of to be transmitted to the plurality of pixel electrodes P1 through the plurality of data lines D1 to DN and the plurality of first switch elements T1 to TN, so that the display panel 11 can normally display the image frame.

In summary, with the above-mentioned liquid crystal display device and the driving method thereof, this disclosure has the advantages of the simple control and low cost, and also completely eliminates the white flickering phenomenon of the liquid crystal display device at the booting-up moment and improves the frame quality of the liquid crystal display device.

Although the present disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present disclosure.

What is claimed is:

1. A method of driving a liquid crystal display device, wherein the liquid crystal display device has a display panel and a drive circuit electrically connected to the display panel, the display panel comprises a plurality of pixels, each of the plurality of pixels has a plurality of first switch elements, a plurality of pixel electrodes and a common electrode, and the drive circuit is electrically connected to the plurality of pixel electrodes through the plurality of first switch elements, respectively, the method comprising:
when the liquid crystal display device is at a booting-up moment and a trigger signal turns on the plurality of first switch elements at a first time point, the drive circuit enables a common electrode voltage to be transmitted to the plurality of pixel electrodes at the first time point; and
when a rising edge of a start signal of a first frame image is received at a second time point after the first time point, the drive circuit enables a plurality of data voltages to be transmitted to the plurality of pixel electrodes through the plurality of first switch elements, so that the plurality of pixels display an image.

2. The method according to claim 1, wherein the drive circuit comprises a source driver and a common-electrode voltage drive circuit; the common-electrode voltage drive circuit comprises a plurality of second switch elements, a third switch element and a logic control circuit; the plurality of second switch elements are correspondingly disposed on a plurality of data lines; and the source driver is electrically connected to the plurality of pixel electrodes through the plurality of data lines, the plurality of second switch elements and the plurality of first switch elements, respectively.

3. The method according to claim 2, wherein when the trigger signal is a first trigger level at the first time point, the third switch element turns on, the logic control circuit controls the plurality of second switch elements to turn off, and the source driver enables the common electrode voltage to be transmitted to the plurality of pixel electrodes through the plurality of data lines, the third switch element and the plurality of first switch elements, respectively.

4. The method according to claim 3, wherein when the trigger signal is a second trigger level to turn on the plurality of second switch elements, the third switch element turns off, and the source driver transmits the plurality of data voltages to the plurality of pixel electrodes through the plurality of data lines, the plurality of second switch elements and the plurality of first switch elements.

5. The method according to claim 2, wherein the logic control circuit is a NOT gate.

6. The method according to claim 1, wherein the drive circuit has a gate driver and a source driver, the gate driver is electrically connected to the plurality of first switch elements of the plurality of pixels, and the source driver is electrically connected to the plurality of first switch elements through a plurality of data lines.

7. The method according to claim 6, wherein when the trigger signal is a first trigger level at the first time point, the gate driver controls the plurality of first switch elements to turn on, and an enable signal controls the source driver to enable the common electrode voltage to be transmitted to the plurality of pixel electrodes through the plurality of data lines at the first time point.

8. The method according to claim 7, wherein at the second time point, the enable signal controls the source driver to enable the plurality of data voltages to be transmitted to the plurality of pixel electrodes through the plurality of data lines.

9. The method according to claim 1, wherein the drive circuit comprises a gate driver, and the trigger signal further enables the gate driver to control the plurality of first switch elements to turn on through a plurality of gate lines at the first time point.

10. The method according to claim 1, wherein before the second time point, pixel voltages of the plurality of pixels are equal to zero.

11. A liquid crystal display device, comprising:
a display panel, comprising a plurality of pixels, wherein each of the plurality of pixels has a plurality of first switch elements, a plurality of pixel electrodes and a common electrode; and
a drive circuit, electrically connecting to the display panel and electrically connecting to the plurality of pixel electrodes through the plurality of first switch elements, respectively;
wherein when the liquid crystal display device is at a booting-up moment and a trigger signal turns on the plurality of first switch elements at a first time point, the drive circuit enables a common electrode voltage to be transmitted to the plurality of pixel electrodes at the first time point; and when a rising edge of a start signal of a first frame image is received at a second time point after the first time point, the drive circuit enables a plurality of data voltages to be transmitted to the plurality of pixel electrodes through the plurality of first switch elements, so that the plurality of pixels display an image.

12. The liquid crystal display device according to claim 11, wherein the drive circuit comprises a source driver and a common-electrode voltage drive circuit; the common-electrode voltage drive circuit comprises a plurality of second switch elements, a third switch element and a logic control circuit; the plurality of second switch elements are correspondingly disposed on a plurality of data lines; and the source driver is electrically connected to the plurality of pixel electrodes through the plurality of data lines, the plurality of second switch elements and the plurality of first switch elements, respectively.

13. The liquid crystal display device according to claim 12, wherein when the trigger signal is a first trigger level at the first time point, the third switch element turns on, the logic control circuit controls the plurality of second switch elements to turn off, and the source driver enables the common electrode voltage to be transmitted to the plurality of pixel electrodes through the plurality of data lines, the third switch element and the plurality of first switch elements, respectively.

14. The liquid crystal display device according to claim 13, wherein when the trigger signal is a second trigger level to turn on the plurality of second switch elements, the third switch element turns off, and the source driver transmits the plurality of data voltages to the plurality of pixel electrodes through the plurality of data lines, the plurality of second switch elements and the plurality of first switch elements.

15. The liquid crystal display device according to claim 12, wherein the logic control circuit is a NOT gate.

16. The liquid crystal display device according to claim 11, wherein the drive circuit has a gate driver and a source driver, the gate driver is electrically connected to the plurality of first switch elements of the plurality of pixels, and the source driver is electrically connected to the plurality of first switch elements through a plurality of data lines.

17. The liquid crystal display device according to claim 16, wherein when the trigger signal is a first trigger level at the first time point, the gate driver controls the plurality of first switch elements to turn on, and an enable signal controls the source driver to enable the common electrode voltage to be transmitted to the plurality of pixel electrodes through the plurality of data lines at the first time point.

18. The liquid crystal display device according to claim 17, wherein at the second time point, the enable signal controls the source driver to enable the plurality of data voltages to be transmitted to the plurality of pixel electrodes through the plurality of data lines.

19. The liquid crystal display device according to claim 11, wherein before the second time point, pixel voltages of the plurality of pixels are equal to zero.

20. A liquid crystal display device, comprising:
a display panel, comprising a plurality of pixels, wherein each of the plurality of pixels has a plurality of first switch elements, a plurality of pixel electrodes and a common electrode; and
a drive circuit, electrically connecting to the display panel and electrically connecting to the plurality of pixel electrodes through the plurality of first switch elements, respectively;
wherein when the liquid crystal display device is at a booting-up moment and a trigger signal turns on the plurality of first switch elements at a first time point, the drive circuit enables a common electrode voltage to be transmitted to the plurality of pixel electrodes at the first time point; and when a rising edge of a start signal of a first frame image is received at a second time point after the first time point, the drive circuit enables a plurality of data voltages to be transmitted to the plurality of pixel electrodes through the plurality of first switch elements, so that the plurality of pixels display an image;
wherein the drive circuit comprises a source driver and a common-electrode voltage drive circuit; the common-electrode voltage drive circuit comprises a plurality of second switch elements, a third switch element and a logic control circuit; the plurality of second switch elements are correspondingly disposed on a plurality of data lines; and the source driver is electrically connected to the plurality of pixel electrodes through the plurality of data lines, the plurality of second switch elements and the plurality of first switch elements, respectively;
wherein when the trigger signal is a first trigger level at the first time point, the third switch element turns on, the logic control circuit controls the plurality of second switch elements to turn off, and the source driver enables the common electrode voltage to be transmitted to the plurality of pixel electrodes through the plurality of data lines, the third switch element and the plurality of first switch elements, respectively;
wherein when the trigger signal is a second trigger level to turn on the plurality of second switch elements, the third switch element turns off, the source driver transmits the plurality of data voltages to the plurality of pixel electrodes through the plurality of data lines, the plurality of second switch elements and the plurality of first switch elements.
